(19) United States
(12) Patent Application Publication
(10) Pub. No.: US 2002/0186893 A1
(43) Pub. Date: Dec. 12, 2002

(54) Nonlinear processing for mitigation of diffraction effects

(76) Inventor: Vasilis Z. Marmarelis, Irvine, CA (US)

Correspondence Address: OPPENHEIMER WOLFF & DONNELLY LLP, 2029 CENTURY PARK EAST, 38TH FLOOR, LOS ANGELES, CA, 90067-3024, US

(21) Appl. No.: 10/117,468

(22) Filed: Apr. 5, 2002

Related U.S. Application Data
(60) Provisional application No. 60/282,002, filed on Apr. 6, 2001.

(51) Int. Cl. G06K 9/40; G06T 5/00

(52) U.S. Cl. 382/260; 382/131; 382/275

(57) ABSTRACT

A combined linear filtering with nonlinear processing that can process the received data to reduce errors due to the effects of diffraction of a signal about an object. The method achieves this with high efficiency (near real-time). This processing operator has a specific computational form with a set of parameters that can be selected appropriately in each give application.

### RELATED APPLICATIONS

The present application claims priority to provisional application serial No. 60/282,002, filed Apr. 6, 2001, the contents of which are hereby incorporated by reference in their entirety.

### BACKGROUND OF THE INVENTION

1. Field of the Invention

This invention relates to imaging a two or three dimensional object using high resolution scanning in tomographical applications.

Specifically, the present invention relates to signal processing systems and methods for improving the telemetric resolution of an object by mitigating the effects of diffraction of a transmitted signal due to the presence of an object.

2. General Background

This invention relates to signal processing systems and methods for the mitigation of diffraction effects. Previous attempts have utilized a gamut of systems ranging from inverse scattering methods to linear deconvolution methods.

There are some potential disadvantages of using the above systems and methods for high quality imaging in tomographic applications. For example, inverse scattering systems are computationally intensive for any application of sufficient complexity to be of practical use.

Linear deconvolution systems are often inadequate because the diffraction process (that hampers the quality of high resolution imaging) is nonlinear in terms of its telemetric or imaging effects. Specifically, when diffraction occurs, the principles of linear systems, such as, linear superposition and scaling generally do not hold.

### SUMMARY OF THE INVENTION

The present invention is directed towards reducing the adverse effects of diffraction around objects that limit the telemetric resolution of an object of interest. The present system and method achieves this improvement even when the dimension of the object is in the sub-millimeter range and the refractive indices are relatively high. The present invention utilizes a combination of at least one linear filter and a nonlinear processing operator operating on the output of the at least one linear filter. It addresses the diffraction problem that causes poor telemetric resolution of an object. As a result, the diffraction effects can be mitigated so that telemetric detection and imaging quality improve significantly in a computationally efficient manner.

Applications of the subject invention are vast and include ultrasonic computed tomography for medical applications and industrial applications of non-destructive evaluation. The invention also enhances the imaging quality of synthetic aperture radar or sonar systems, as well as optical systems where the wavelength compares with the dimensions of the objects of interest (e.g., microscopy, or space imaging).

In one embodiment of the present invention, a system for creating an image of an object that is at a high resolution comprises, (i) at least one filter receiving diffracted image data as input and having a filter output, the at least one filter implementing a vector basis, and (ii) a processor receiving the filter output as input and having a processor output that is a non-linear function of the filter output, the non-linear function having at least one adjustable parameter. In one aspect, the vector basis could be an eigenvector corresponding to an eigenvalue of a correlation matrix of the diffracted image data. In another illustrative aspect, the vector basis could be determined through principal component analysis (PCA), independent component analysis (ICA), or wavelet decomposition of image data. Furthermore, the nonlinear function could be differentiable with at least one adjustable parameter that could be adjusted by an algorithm such as the gradient descent algorithm or by minimizing a difference between the output of the nonlinear function and a reference signal.

In another embodiment of the present invention, a method for creating an image of an object that is at a high resolution comprises: (i) delivering a diffracted image data to at least one filter that implements a vector basis, the at least one filter having a filter output, and (ii) delivering the filter output to a processor having a processor output, the processor output being a non-linear function of the filter output. In one aspect, the vector basis could be an eigenvector corresponding to an eigenvalue of a correlation matrix of the diffracted image data. In another illustrative aspect, the vector basis could be determined through principal component analysis (PCA), independent component analysis (ICA), or wavelet decomposition of image data. Furthermore, the nonlinear function could be differentiable with at least one adjustable parameter that could be adjusted by an algorithm such as the gradient descent algorithm or by minimizing a difference between the output of the nonlinear function and a reference signal.

### BRIEF DESCRIPTION OF THE DRAWINGS

In order that the manner in which the above-recited advantages and objects of the invention are attained, as well as others which will become apparent, more particular description of the invention briefly summarized above may be had by reference to the specific embodiments thereof that are illustrated in the appended drawings. It is to be understood, however, that the appended drawings illustrate only typical embodiments of the invention and are therefore not to be considered limiting of its scope, for the invention may admit to other equally effective embodiments.

FIG. 1 is a general overview of one embodiment of a system incorporating the present invention for improving the telemetric resolution of an object by mitigating diffraction effects.

FIG. 2 shows one embodiment of components that implement the present invention for improving telemetric resolution of an object of interest by mitigating diffraction effects.

FIG. 3 is a block diagram depicting an adaptive process for adjusting the parameter(s) of the nonlinear function by minimizing a difference between the output and a reference signal, the nonlinear function being one component that implements the present invention for improving telemetric resolution of an object of interest.

FIG. 4 is a plot, resulting upon the use of the present invention, showing significant reduction in the errors due to the effects of diffraction in one dimensional image data of a sphere of 1 mm radius having a refractive index 1.05.

FIG. 5 is a plot, resulting upon the use of the present invention, showing significant reduction in the errors due to the effects of diffraction in one dimensional image data of a sphere of 0.5 mm radius (sub-mm radius) having a refractive index 1.05.

FIG. 6 is a plot, resulting upon the use of the present invention, showing significant reduction in the errors due to the effects of diffraction in one dimensional image data of a sphere of 1 mm radius having a refractive index 0.95.

FIG. 7 is a plot, resulting upon the use of the present invention, showing significant reduction in the errors due to the effects of diffraction in one dimensional image data of a sphere of radius 0.5 mm and having a refractive index of 0.95.

### DETAILED DESCRIPTION OF ILLUSTRATIVE EMBODIMENTS OF THE INVENTION

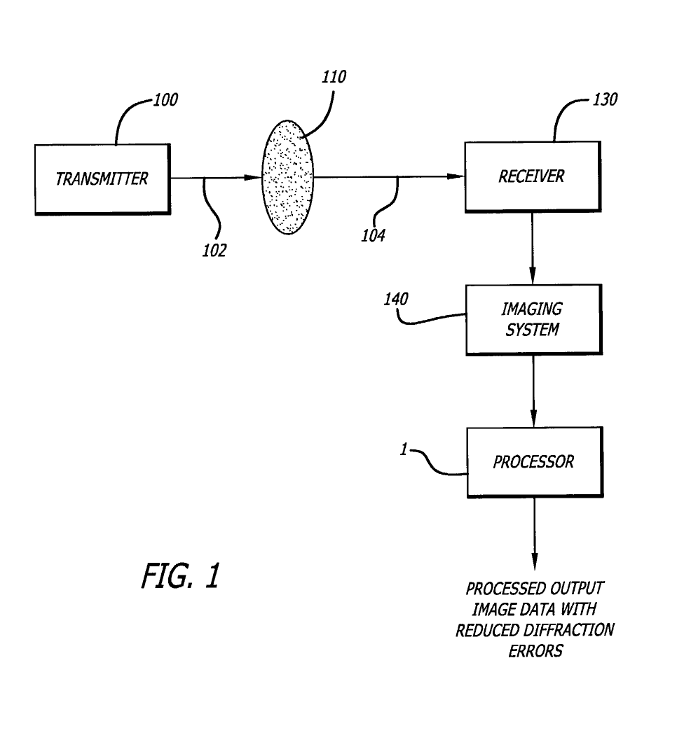

The general overview of one embodiment of a system incorporating the present invention for improving the telemetric resolution of an object is shown in FIG. 1. A transmitter 100, that could be a simple quartz piezoelectric crystal, transmits a pulse signal 102 towards a receiver 130. In one illustrative aspect the frequency of the signal could be in the ultrasonic range (e.g., 1-15 MHz) greater than 15 MHz. The output from the receiver 130 is passed to a processor 1. The transmitted signal 102 is attenuated by the medium in which the signal propagates and is also diffracted, and possibly attenuated, by an object 110 located between the transmitter 100 and the receiver 130. The signal 104 is directed from the object 110 to the receiver 130 is attenuated and diffracted due to the presence of the object 110. The object could be biological (e.g., a gland or a breast) or it could be an article such as a metal sphere. This diffraction of a signal about an object causes a halo/sidelobe effect, in the projection image formed by the received signal, that interferes with the accurate estimation of the dimensions of an object. Thus, a processor 1, according to the present invention, is used to process the image data in order to reduce sidelobe effects. The details of the processor 1 are given below.

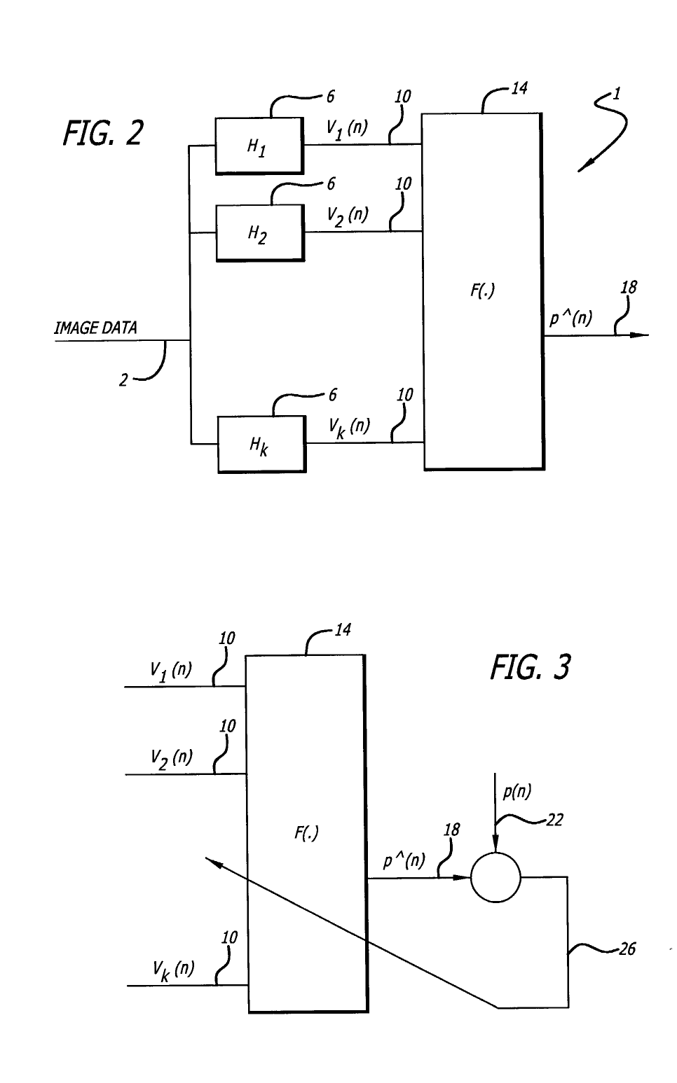

In one embodiment, the processor 1 is a signal processing system, as depicted in FIG. 2, having components that improve telemetric resolution of an object of interest by reducing errors in the projection image formed by the received diffracted signal. In one embodiment, the signal processing system 1 includes a combination of at least one linear filter and a non-linear operator for processing the diffracted image data.

The image data represented by signal 2 labeled r(n), is preferably in digitized form. In one embodiment, the signal r(n) is image data having diffraction errors. This image data may be created by an imaging system 140 (as shown in FIG. 1) or an image processing system in a manner that is well known to one skilled in the art. The processed signal, which is the image data, is then applied as input to at least one linear filter depicted as H_{K}, 6. As an example the filter H_{K}, 6, is a linear filter with a discrete impulse response function h_{K}(n) determined by the correlation matrix of test data (as explained later). Even though a plurality of linear filters have been shown in FIG. 2, it is to be understood that the number of these linear filters can be adjusted to reduce errors caused by diffraction. Also, an array of receivers may be used to further reduce errors caused by diffraction thereby improving the resolving power or imaging ability of the system.

A nonlinear processor F[.] 14, in cascade with the linear filter(s) 6, is in one embodiment a multivariate nonlinear function operating on the outputs {v_{K}(n)}, 10, of the filters {H_{K}} 6 to produce the processed data pÂ (n) 18 that have reduced errors due to diffraction effects. Reducing diffraction effects from the received signal improves the image quality of an object by reducing telemetric sidelobes, thereby allowing better estimation of the dimensions of the object.

The form of the discrete functions {h_{K}(n)} (corresponding to {H_{K}} 6)and F[.] 14 is determined in each application from test data. For example, a matrix of test data with diffraction effects of objects of interest is used to obtain the discrete functions {h_{K}(n)} as a vector basis. In one embodiment, this vector basis could be eigenvectors corresponding to the significant eigenvalues (or singular values, if singular value decomposition is used) of the correlation matrix of the test data. Even though the impulse response functions of the filters are defined to be the eigenvectors associated with the eigenvalues of the correlation matrix, it should be understood that any coordinate system of properly selected vector basis that span the signal space can be used. For example, the selected vectors could form an orthonormal basis spanning the signal space. Alternatively, the vector basis could be determined through principal component analysis (PCA), independent component analysis (ICA), or wavelet decomposition of image data, a process well known to one skilled in the art.

The parameters of the constrained nonlinear function F, 14, can be determined adaptively by fitting the recorded test data 2 to the known target data 22. This is shown in FIG. 3, and described later through equations 5 and 6. If the test data is sufficiently representative of images of interest, then the resulting nonlinear operator 14 can be used to mitigate the diffraction effects in recorded data of unknown targets. This is illustrated though the following exemplary mathematical expressions for the receiver/processor 1 signal processing system.

νₖ(n)=Σhₖ(m)r(n−m) (1)

\hat{p}(n)=F[ν₁(n), . . . ,ν_{K}(n);α] (2)

where α is a parameter vector for a specified form of the nonlinear function F[.] 14 (e.g., coefficients if a multinomial expression is chosen).

The discrete functions {h_{K}(m)} are obtained from the correlation matrix R of the test data as eigenvectors corresponding to the significant eigenvalues of the matrix:

$$R = [ \begin{matrix}φ ( 0 ) & φ ( 1 ) & … & φ ( M ) \\ φ ( 1 ) & φ ( 0 ) & … & φ ( M - 1 ) \\ ⋮ & & & \\ φ ( M ) & φ ( M - 1 ) & … & φ ( 0 )\end{matrix} ] \qquad ( 3 )$$

where,

$$φ ( m ) = \frac{1}{( N + 1 - m )} {\sum }_{n = m}^{N} r ( n ) r ( n - m ) \qquad ( 4 )$$

The criterion for selecting the “significant” eigenvalues (and the corresponding eigenvectors) depends on signal-to-noise ratio (SNR) considerations. The smallest selected eigenvalue is preferably just above the largest noise eigenvalue. Having selected the discrete functions {h_{K}(m)}, the discrete functions {v_{K}(m)} 10 can be computed using Eq. (1). Then the parameter vector a of the nonlinear function F 14 is estimated by fitting the target data p(n) 22 to the output signal \hat{p}(n) given by equation (2).

For instance, if a least-squares criterion is used, then the following iterative relation can be used to adjust/update the parameter vector of the nonlinear processor 14, using gradient descent, if the nonlinear function F is differentiable:

$${\hat{\underline{α}}}_{f + 1} = {\hat{\underline{α}}}_{f} + γ [ p ( n ) - {\hat{p}}_{i} ( n ) ] \cdot \frac{\partial F}{\partial \underline{α}} {\vert}_{∝ = {\hat{α}}_{i}} \qquad ( 5 )$$

where i denotes the iteration index, γ is the iteration step, and:

\hat{p}(n)=F[ν₁(n), . . . νₖ(n);\hat{α}ᵢ] (6)

The adjustment mechanism for the parameter vector α is governed by the product of the following three quantities: (i) output of a comparator that computes a difference of a reference signal 22 from the nonlinear processor output 18, (ii) the iteration step or learning rate, and (iii) a gradient of the nonlinear function relative to the parameter vector a.

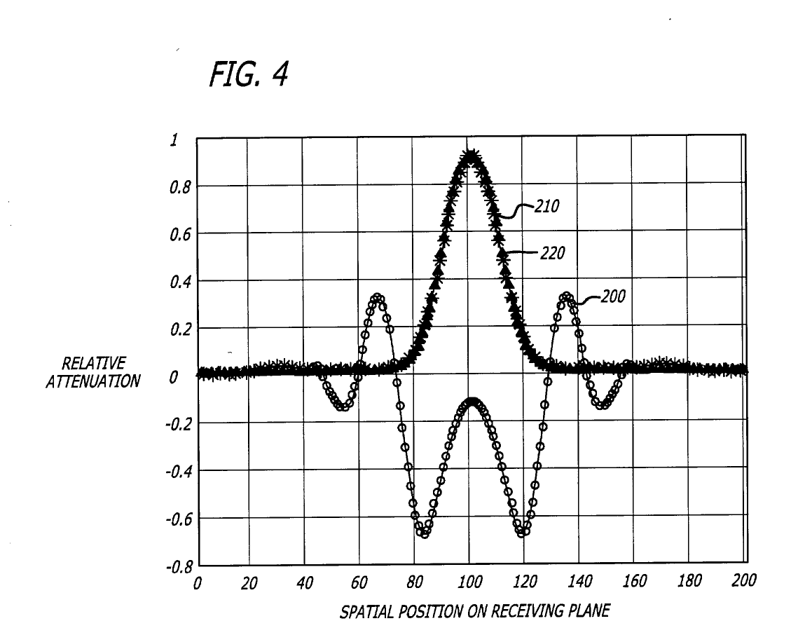

The experiment for testing the system is done using simulations of the acoustic wave-equation where an incident plane wave scatters upon interaction with an object. The plots in FIGS. 4-7 represent peak pressure values of forward scatter values versus radial location at a receiving plane placed 5 cm after the object. The X-axis in the plot indicates the one dimensional space location at the receiving plane, whereas the Y-axis indicates the attenuation of the received pressure pulse expressed as −log(P₁/P₂), where P₁ is the maximum value of the received pressure pulse, and P₂ is a reference value, corresponding to the case without an object.

FIG. 4 is a plot, resulting upon the use of the present invention, showing significant reduction in the errors due to the effects of diffraction about a sphere of 1 mm radius having a refractive index 1.05. In one embodiment, at least one transmitter transmits an ultrasonic signal, to at least one receiver that is situated approximately 10 cm from the transmitter. The transmitted signal has a center frequency of approximately 8 MHz. The processed received signal representing image data is marked by circles 200. This signal shows large sidelobes due to the effects of diffraction of the transmitted signal about the object. The target signal corresponding to the actual profile of the sphere is marked by asterisks 210. It is required that the output from the signal processing system 1 approximate the target signal 210 for achieving an improvement in the telemetric resolution or imaging quality of the object.

The output of the nonlinear processor is shown in FIG. 4 as triangles 220 after proper adjustment of the parameters of the nonlinear function (using eq. (5)). The system removes totally the diffraction effects and improves the telemetric resolution or imaging quality of the object when the original image data (circles) is applied to eight linear filters and a quadratic nonlinear processor, in this example. This is achieved by reducing errors in the diffracted image data by the signal processing system 1 according to the present invention, using the gradient descent method of Eq. (5) in this example.

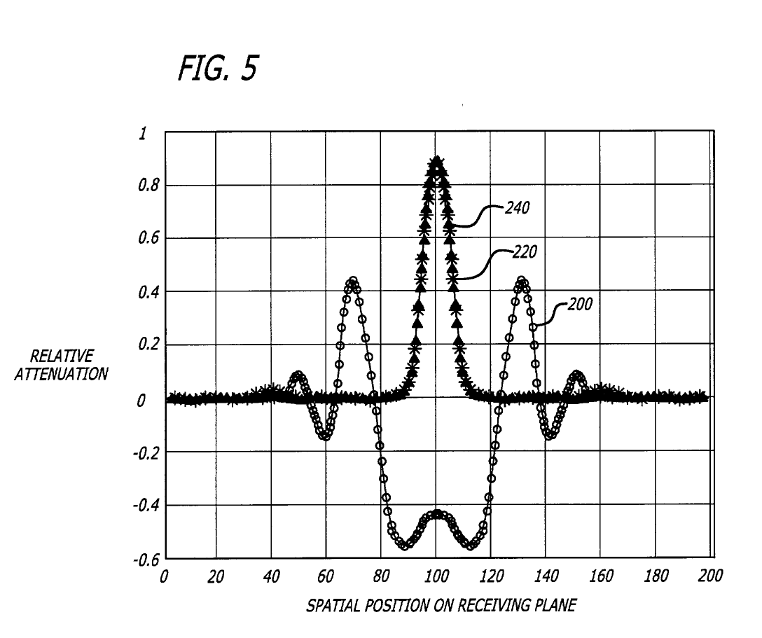

FIG. 5 shows another illustrative example of one of the applications of the present invention. In one embodiment, at least one transmitter transmits an ultrasonic signal, to at least one receiver that is situated approximately 10 cm from the transmitter. The transmitted signal has a center frequency of approximately 8 MHz. The test object of interest is a sphere of radius 0.5 mm (i.e., in the sub-millimeter dimension) and having a refractive index of 1.05. The image data is marked by circles 200. This signal again shows large sidelobes due to the effects of diffraction about the object. The output of the nonlinear processor is shown in FIG. 5 as triangles 240 after proper adjustment of the parameters of the nonlinear function (using eq. (5)). Clearly, the system is again able to improve the telemetric resolution or imaging quality of the object when the measured image data is applied to the combination of eight linear filters and a quadratic nonlinear processor.

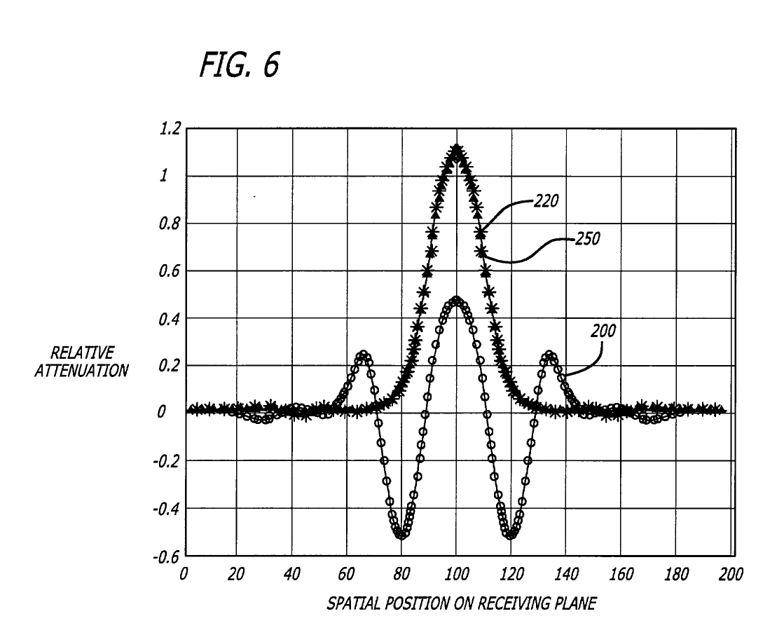

FIG. 6 shows yet another illustrative example of one of the applications of the present invention. Specifically, at least one transmitter transmits an ultrasonic signal, to at least one receiver that is situated approximately 10 cm from the transmitter. The transmitted signal has a center frequency of approximately 8 MHz. The object of interest is a sphere of radius 1 mm and having a refractive index of 0.95. The image data is marked by circles 200. This signal again shows large sidelobes due to the effects of diffraction about the object. The output of the nonlinear processor is shown in FIG. 6 as triangles 250 after proper adjustment of the parameters of the nonlinear function (using eq. (5)). Clearly, the system is again able to improve the telemetric resolution or imaging quality of the object when the measured image data is applied to the combination of eight linear filters and a quadratic nonlinear processor.

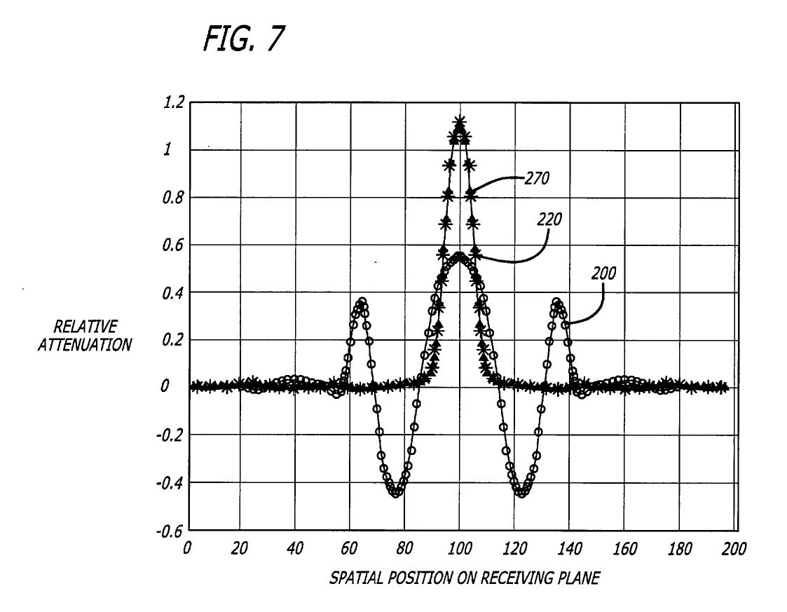

FIG. 7 shows yet another illustrative example of one of the applications of the present invention. Specifically, at least one transmitter transmits an ultrasonic signal, to at least one receiver that is situated approximately 10 cm from the transmitter. The transmitted signal has a center frequency of approximately 8 MHz. The object of interest is a sphere of radius 0.5 mm (i.e., sub-millimeter dimension) and having a refractive index of 0.95. The image data is marked by circles 200. This signal again shows large sidelobes due to the effects of diffraction about the object. The output of the nonlinear processor is shown in FIG. 7 as triangles 270 after proper adjustment of the parameters of the nonlinear function (using eq. (5)). Clearly, the system is again able to improve the telemetric resolution or imaging quality of the object when the measured image data is applied to the combination of eight linear filters and a quadratic nonlinear processor.

While the specification describes particular aspects of the present invention, those of ordinary skill can devise variations of the present invention without departing from the inventive concept. For example, the number of linear filters or the form of the nonlinearity used can be selected adaptively depending on the nature of the problem. Also, one nonlinear processor was shown in FIG. 2. Alternatively, several adaptive nonlinear processors may be used in parallel.

Having described the invention in detail, those skilled in the art will appreciate that, given the present disclosure, modifications may be made to the invention without departing from the spirit of the inventive concept described herein. Therefore, it is not intended that the scope of the invention be limited to the specific and preferred embodiments illustrated and described. Rather, it is intended that the scope of the invention be determined by the appended claims.

I claim the following:

1. A method for reducing errors due to diffraction of a signal about an object, the method comprising:
directing a first signal toward the object;
receiving a diffracted signal from the object, the diffracted signal resulting from a diffraction of the first signal about the object;
processing the received diffracted signal to form image data, the image data having diffraction errors;
delivering the image data to at least one filter that implements a vector basis, the at least one filter having a filter output; and
delivering the filter output to a processor that has a processor output, the processor output being a non-linear function of the filter output, the non-linear function having at least one adjustable parameter.

2. The method of claim 1 further comprising convolving the image data with the at least one filter.

3. The method of claim 1 wherein the vector basis is an eigenvector corresponding to an eigenvalue of a correlation matrix of the image data.

4. The method of claim 1 wherein a comparison between the processor output and the reference signal is done by computing a difference between the processor output and the reference signal.

5. The method of claim 4 wherein the adjustable parameter is adjusted by minimizing the difference between the processor output and the reference signal.

6. The method of claim 1 wherein the adjustable parameter is adjusted using a gradient descent algorithm.

7. The method of claim 3 wherein the eigenvalue is selected to maximize a signal to noise ratio criterion.

8. The method of claim 1 wherein the vector basis is determined from independent component analysis.

9. The method of claim 1 wherein the vector basis is determined from principal component analysis.

10. The method of claim 1 wherein the vector basis is determined from wavelet decomposition.

11. The method of claim 1 wherein the nonlinear function is differentiable.

12. A method for reducing errors that are present in an image data of an object due to diffraction of a signal about an object, the method comprising:
delivering the image data to at least one filter that implements a vector basis, the at least one filter having a filter output; and
delivering the filter output to a processor having a processor output, the processor output being a non-linear function of the filter output, the non-linear function having at least one adjustable parameter.

13. The method of claim 12 further comprising comparing the processor output with a reference signal.

14. The method of claim 13 further comprising adjusting the at least one adjustable parameter based on the result of the comparison.

15. The method of claim 12 further comprising convolving the image data with the at least one filter.

16. The method of claim 12 wherein the vector basis is an eigenvector corresponding to an eigenvalue of a correlation matrix of the image data.

17. The method of claim 13 wherein the comparison between the processor output and the reference signal is done by computing a difference between the processor output and the reference signal.

18. The method of claim 14 wherein the at least one adjustable parameter is adjusted using a gradient descent algorithm.

19. The method of claim 16 wherein the eigenvalue is selected to maximize a signal to noise ratio criterion.

20. The method of claim 12 wherein the vector basis is determined from independent component analysis.

21. The method of claim 12 wherein the nonlinear function is differentiable.

22. The method of claim 12 wherein the vector basis is determined from principal component analysis.

23. The method of claim 12 wherein the vector basis is determined from wavelet decomposition.

24. A system for reducing errors that are present in an image data of an object due to diffraction of a signal about an object, the system comprising:
at least one filter receiving the image data and having a filter output, the at least one filter implementing a vector basis; and
a processor in communication with the at least one filter and having a processor output that is a non-linear function of the filter output, the non-linear function having at least one adjustable parameter.

25. The system of claim 24 further including a comparator in communication with said processor for comparing the processor output with a reference signal.

26. The system of claim 24 wherein the at least one adjustable parameter is adjusted based on the result of the comparison.

27. The system of claim 24 wherein the image data is convolved with said at least one filter.

28. The system of claim 25 wherein the comparison between the processor output and the reference signal is done by computing a difference between the processor output and the reference signal.

29. The system of claim 26 wherein the at least one adjustable parameter is adjusted using a gradient descent algorithm.

30. The system of claim 24 wherein the vector basis is an eigenvector corresponding to an eigenvalue of a correlation matrix of the image data.

31. The system of claim 24, wherein the vector basis is determined from independent component analysis.

32. The system of claim 30, wherein the eigenvalue is selected to maximize a signal to noise ratio criterion.

33. The system of claim 24 wherein said processor includes a neural network to provide the nonlinear function.

34. The system of claim 24 wherein said processor includes a polynomial to provide the nonlinear function.

35. The system of claim 24 wherein said processor includes a volterra model to provide the nonlinear function.

36. The system of claim 24 wherein the nonlinear function is differentiable.

37. The system of claim 24 wherein the vector basis is determined from principal component analysis.

38. The system of claim 24 wherein the vector basis is determined from wavelet decomposition.

39. A method for reducing errors that are present in an image data of an object due to diffraction of a signal about an object, the method comprising:
delivering the image data to a plurality of discrete filters, each of the plurality of discrete filters having a discrete impulse response function that is a vector basis spanning the signal space to form a co-ordinate system, the each of the plurality of discrete filters having a filter output; and
delivering the filter output to a processor that has a processor output, the processor output being a non-linear function of the filter output, the non-linear function having at least one adjustable parameter.

40. The method of claim 39 wherein each vector basis is an eigenvector corresponding to an eigenvalue of a correlation matrix of the image data.

41. The method of claim 39 wherein the vector basis is determined from independent component analysis.

42. The method of claim 39 wherein the nonlinear function is differentiable.

43. The method of claim 40 wherein the eigenvalue is selected to maximize a signal to noise ratio criterion.

44. The method of claim 39 wherein the vector basis is determined from principal component analysis.

45. The method of claim 39 wherein the vector basis is determined from wavelet decomposition.

46. A system for reducing errors due to diffraction of a signal about an object, the system comprising:
a transmitter for transmitting a first signal;
a receiver for receiving a diffracted signal, the diffracted signal resulting from a diffraction of the first signal about the object;
an imaging system to form image data from the received diffracted signal, the image data having diffraction errors;
at least one filter to receive the image data and having a filter output, the at least one filter implementing a vector basis; and
a processor in communication with said at least one filter and having a processor output that is a non-linear function of the filter output, the non-linear function having at least one adjustable parameter.

47. The system of claim 46 further including a comparator for comparing the processor output with a reference signal.

48. The system of claim 47 further adjusting the adjustable parameter based on the result of the comparison.

49. The system of claim 46 wherein the image data is convolved with the at least one filter.

50. The system of claim 46 wherein each of the vector basis is an eigenvector corresponding to an eigenvalue of a correlation matrix of the image data.

51. The system of claim 46 wherein the vector basis is determined from independent component analysis.

52. The system of claim 46 wherein the nonlinear function is differentiable.

53. The system of claim 48 wherein the comparison between the processor output and the reference signal is done by computing a difference between the processor output and the reference signal.

54. The system of claim 46 wherein the at least one adjustable parameter is adjusted using a gradient descent algorithm.

55. The system of claim 50 wherein the eigenvalue is selected to maximize a signal to noise ratio criterion.

56. The system of claim 46 wherein said processor includes a neural network to provide the nonlinear function.

57. The system of claim 46 wherein said processor includes a polynomial to provide the nonlinear function.

58. The system of claim 46 wherein said processor includes a volterra model to provide the nonlinear function.

59. The system of claim 54 wherein the at least one adjustable parameter is adjusted in proportion to the product of an adaptation rate coefficient and a gradient of the nonlinear function with respect to the at least one adjustable parameter.

60. The system of claim 46 wherein the vector basis is determined from principal component analysis.

61. The system of claim 46 wherein the vector basis is determined from wavelet decomposition.

62. The system of claim 53 wherein the adjustable parameter is adjusted by minimizing the difference between the processor output and the reference signal.
